(19) United States
(12) Patent Application Publication
(10) Pub. No.: US 2021/0192586 A1
(43) Pub. Date: Jun. 24, 2021

(54) Systems and Methods for Detecting and Responding to Anomalous Traffic Conditions

(71) Applicant: Cintra Holding US Corp., Austin, TX (US)

(72) Inventors: Ricardo Sanchez Gomez, Austin, TX (US); John Francis Brady, Austin, TX (US); Vamsi Krishna Nadimpalli, Austin, TX (US)

(21) Appl. No.: 16/828,697

(22) Filed: Mar. 24, 2020

Related U.S. Application Data
(63) Continuation of application No. PCT/US19/67831, filed on Dec. 20, 2019.

(51) Int. Cl. G06Q 30/02; G08G 1/01; G06K 9/62

(52) U.S. Cl. CPC G06Q 30/0284; G08G 1/0129; G06Q 2240/00; G06K 9/6221; G06K 9/6272

(57) ABSTRACT

Aspects of the disclosed technology relate to a computer-implemented method for determining a toll rate for a toll road. In some embodiments, the method comprises receiving, for a time interval, current traffic data comprising a plurality of data attributes, determining a toll rate based on a predetermined toll setting model, determining whether a current vector composed of the traffic data and toll rate is within a cluster of anomalous vectors, and adjusting the toll rate based on a toll adjustment rule associated with the anomalous vector.

### TECHNICAL FIELD

The present invention relates to systems, methods, and computer readable storage media containing instructions for detecting an anomalous traffic condition. Some embodiments further relate to calculating a decision in response to the detection of an anomalous traffic condition, such as selecting a route, setting a speed limit, or setting a toll rate.

### BACKGROUND

The daily commute of many involves trips on public roadways. Those roadways are frequently monitored by one or more detection devices, such as vehicle counters, speed monitors, license plate readers, and other sensing technologies. Roadway data is also often collected from individual drivers, either through their cars or their mobile devices (or similar devices) that report GPS location, speed, and other metrics. Roadway data can also be collected from mobile devices that allow drivers to manually report roadway events (e.g., stopped vehicle, police presence). This roadway data can be used to provide services to drivers, as well as the operators of the public roadways.

Examples of such services to drivers include reporting such data to drivers through mobile data networks, implementing traffic-aware navigation technologies, providing real-time alerts to drivers of unexpected roadway conditions, and other similar practices. Examples of such services to operators of public roadways can involve dynamically setting speed limits or toll rates, estimating roadway wear, developing plans for future highway construction projects, and providing real-time alerts to drivers through public signage or their mobile devices.

For many of these services, the roadway data must be analyzed, and a decision made by a computing system. In order for such a decision to be made, the computing system often must be programmed with complex decision-making logic. In such systems, that decision-making logic can occasionally produce an incorrect result, resulting in non-optimal decision-making (e.g., picking the wrong route, setting a non-optimal toll, or setting a traffic-inducing speed limit).

A non-limiting example of an application of embodiments is on managed toll lanes, whereby a single road segment has public, toll-free unmanaged lanes, and one or more managed toll lanes. On such roads, the toll charged for use of the managed lanes is often dynamic, and can be adjusted in response to traffic conditions. In some circumstances, the toll can be adjusted in response to current roadway information, or in response to a prediction of future roadway conditions. Further, because managed lanes frequently have only a few discrete points of entry, after which a vehicle must travel in the toll lane for a period of time, adjusting the toll in response to current conditions may be non-optimal, and instead the toll should be set based on predictions of future road conditions. That is, a decision on whether to take the managed toll lane must be made at the beginning of using a toll lane, but the expected effect (enhanced travel time, etc.) is experienced during some duration of time following that decision.

These adjustments can be performed automatically in response to such data through various algorithms set by human programmers to accomplish such goals as achieving a predetermined speed on the managed lanes, maximizing throughput throughout the entire roadway, and maximizing toll revenue, among other ends. Nevertheless, current systems are limited in that they often produce incorrect or non-optimal results in response to anomalous or unexpected roadway conditions.

What is needed, therefore, is a method for determining whether a traffic-based decision is being based on an anomalous set of circumstances, or producing an anomalous result in need of correction. What is further needed is a method for addressing such anomalous conditions by, for example, providing alternative decision-making strategies in those circumstances. Systems and methods are described herein for accomplishing this and other purposes.

### SUMMARY

Aspects of the present disclosed technology relate to a computer-implemented method for determining a toll rate for a toll road, comprising: receiving, for a time interval, current traffic data comprising a plurality of data attributes, composed of: roadway traffic data tolling traffic data, and calculated traffic data; determining a toll rate based on a predetermined toll setting model, determining whether a current vector composed of the traffic data and toll rate is within a cluster of anomalous vectors, and adjusting the toll rate based on a toll adjustment rule associated with the anomalous vector, wherein the toll adjustment rule is determined by: receiving, for a plurality of time intervals, historical traffic data comprising the plurality of data attributes, and a toll rate corresponding to each time interval, collating the historical traffic data and toll rate into a plurality of vectors, wherein each vector comprises the traffic data and toll rate corresponding to a single time interval; identifying a plurality of anomalous vectors from within the plurality of vectors, where each vector in the set of anomalous vectors is anomalous relative to the plurality of vectors; grouping the set of anomalous vectors into a plurality of anomalous vector clusters, wherein each anomalous vector cluster comprises a subset of anomalous vectors selected from the set of anomalous vectors, and wherein each anomalous vector in an anomalous vector cluster is closer to other anomalous vectors in the anomalous vector cluster than to anomalous vectors in other anomalous vector clusters, according to a distance metric; and analyzing the vectors in a vector cluster to determine the toll adjustment rule associated with the vector cluster.

In some embodiments, the method can further comprise the step of analyzing the vectors in a vector cluster to determine the toll adjustment rule associated with the vector cluster comprises determining a toll adjustment rule that, when applied to the vectors in the vector cluster, would reduce the anomalousness of the vectors in the vector cluster. In some embodiments, the step of determining whether a vector composed of the traffic data and toll rate is within a cluster of anomalous vectors comprises, for each vector cluster in the plurality of vector clusters: determining a centroid of the vector cluster, determining a standard deviation of the distance of each vector in the vector cluster from the centroid, determining that a current vector is within a cluster of anomalous vectors where the current vector is closer than a predetermined number of standard deviations from the centroid of the vector cluster. In some embodiments, the step of analyzing the vectors in a vector cluster to determine the toll adjustment rule comprises determining an average toll adjustment necessary to move each vector in the vector cluster to the closest vector in the plurality of vectors that is not in the plurality of anomalous vectors. In some embodiments, the step of analyzing the vectors in a vector cluster to determine the toll adjustment rule comprises determining a toll adjustment necessary to move a vector representing the centroid of the vector cluster to the closest vector in the plurality of vectors that is not in the plurality of anomalous vectors. In some embodiments, the step of identifying a plurality of anomalous vectors from within the plurality of vectors comprises: determining an anomaly score for each vector in the plurality of vectors, identifying a vector as an anomalous vector where the anomaly score for the vector is beyond a threshold anomaly score. In some embodiments, the current traffic data and the historical traffic data comprise data attributes for a plurality of road segments.

Aspects of the presently disclosed technology further include computing systems configured to perform these methods, and computer-readable storage media for performing these methods. The presently disclosed technology is not, however, limited to only these features, and includes such other features and embodiments as are described herein.

### BRIEF DESCRIPTION OF THE FIGURES

Included in the present specification are figures which illustrate various embodiments of the present disclosed technology. As will be recognized by a person of ordinary skill in the art, actual embodiments of the disclosed technology need not incorporate each and every component illustrated, but may omit components, add additional components, or change the general order and placement of components. Reference will now be made to the accompanying figures and flow diagrams, which are not necessarily drawn to scale, and wherein:

FIG. 1 depicts a computing device in accordance with embodiments.

FIG. 2 depicts a cloud computing environment in accordance with embodiments.

FIG. 3 depicts an example system architecture for a traffic management system in accordance with embodiments.

FIG. 4 depicts an example system for analyzing and clustering historical data in accordance with embodiments.

FIG. 5 depicts example methods for assigning new data to existing clusters of data, in accordance with embodiments.

FIG. 6 depicts a computer-implemented method in accordance with embodiments.

### DETAILED DESCRIPTION

The following detailed description is directed to systems, methods, and computer-readable media for detecting and responding to anomalies in a traffic management system.

Although example embodiments of the present disclosure are explained in detail, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Moreover, titles or subtitles may be used in this specification for the convenience of a reader, which have no influence on the scope of the present disclosure.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose.

It is to be understood that the mention of one or more steps of a method does not preclude the presence of additional method steps or intervening method steps between those steps expressly identified. Steps of a method may be performed in a different order than those described herein. Similarly, it is also to be understood that the mention of one or more components in a device or system does not preclude the presence of additional components or intervening components between those components expressly identified.

In the following detailed description, references are made to the accompanying drawings that form a part hereof and that show, by way of illustration, specific embodiments or examples. In referring to the drawings, like numerals represent like elements throughout the several figures.

Various products and services provided by third parties are mentioned as example components of embodiments in accordance with the disclosed technologies. The use of trademarked (registered or common-law) names are intended for descriptive purposes only—no claim of ownership over the terms is asserted by the applicants. Further, the mention of a trademarked product or service is as an example only. Other products and services providing equivalent functions, whether commercial, open-source, or custom-developed to support embodiments are contemplated in accordance with the disclosed technology.

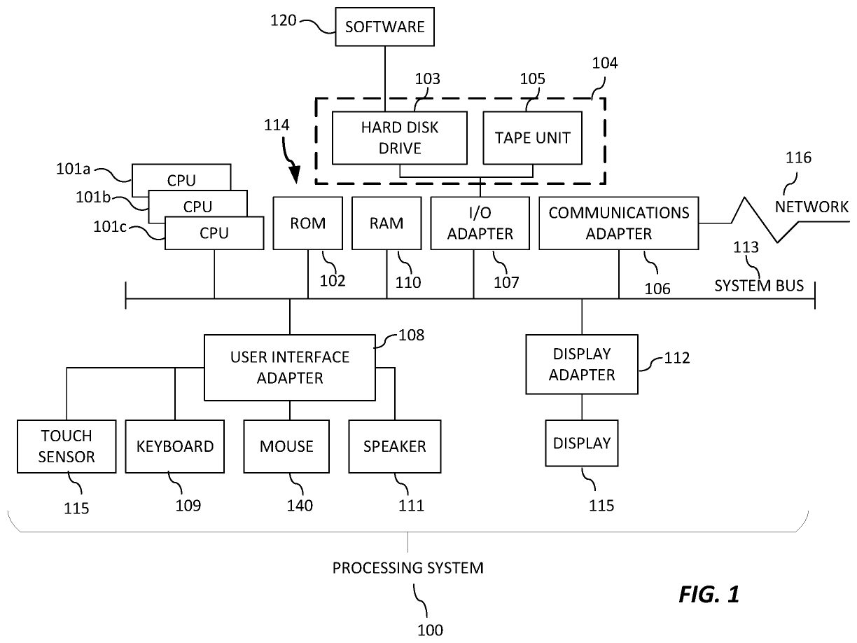

Referring now to FIG. 1, there is shown an embodiment of a processing system 100 for implementing the teachings herein. In this embodiment, the processing system 100 has one or more central processing units (processors) 101a, 101b, 101c, etc. (collectively or generically referred to as processor(s) 101). Processors 101, also referred to as processing circuits, are coupled to system memory 114 and various other components via a system bus 113. Read only memory (ROM) 102 is coupled to system bus 113 and may include a basic input/output system (BIOS), which controls certain basic functions of the processing system 100. The system memory 114 can include ROM 102 and random access memory (RAM) 110, which is read-write memory coupled to system bus 113 for use by processors 101.

FIG. 1 further depicts an input/output (I/O) adapter 107 and a network adapter 106 coupled to the system bus 113. I/O adapter 107 may be a small computer system interface (SCSI) adapter that communicates with a hard disk (magnetic, solid state, or other kind of hard disk) 103 and/or tape storage drive 105 or any other similar component. I/O adapter 107, hard disk 103, and tape storage drive 105 are collectively referred to herein as mass storage 104. Software 120 for execution on processing system 100 may be stored in mass storage 104. The mass storage 104 is an example of a tangible storage medium readable by the processors 101, where the software 120 is stored as instructions for execution by the processors 101 to implement a circuit and/or to perform a method. Network/communications adapter 106 interconnects system bus 113 with an outside network 116 enabling processing system 100 to communicate with other such systems. A screen (e.g., a display monitor) 115 is connected to system bus 113 by display adapter 112, which may include a graphics controller to improve the performance of graphics intensive applications and a video controller. In one embodiment, adapters 107, 106, and 112 may be connected to one or more I/O buses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 140, and speaker 111 can be interconnected to system bus 113 via user interface adapter 108, which may include, for example, a Super I/O chip integrating multiple device adapters into a single integrated circuit.

Thus, as configured in FIG. 1, processing system 100 includes processing capability in the form of processors 101, and, storage capability including system memory 114 and mass storage 104, input means such as a keyboard 109, mouse 140, or touch sensor 115 (including touch sensors 109 incorporated into displays 115), and output capability including speaker 111 and display 115. In one embodiment, a portion of system memory 114 and mass storage 104 collectively store an operating system to coordinate the functions of the various components shown in FIG. 1.

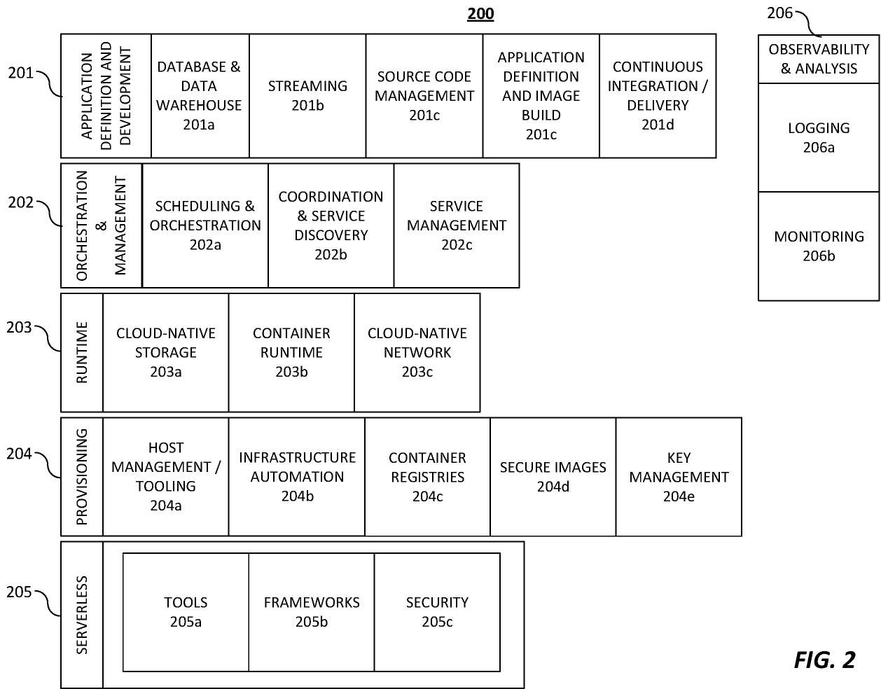

Embodiments of the present technology can also be implemented using cloud-based technologies, such as those depicted in FIG. 2. Cloud native technologies include scalable applications in modern, dynamic environments such as public, private, and hybrid clouds. Containers, service meshes, microservices, immutable infrastructure, and declarative APIs exemplify this approach. These techniques enable loosely coupled systems that are resilient, manageable, and observable.

Embodiments of the disclosed technology can be built using one or more elements of cloud computing technology as shown in FIG. 2. Cloud technologies can include application definition and development tools 201, orchestration & management tools 202, runtime tools 203, provisioning tools 204, serverless components 205, and observability & analysis tools 206.

Application definition and development components 201 (“ADD”) enable developers to define and develop applications prior to deployment, and to refine those designs in subsequent versions. ADD components 201 can include database and data warehouse components 201a that provide data sets and data storage for application development. These database and data warehouse components 201a include relational and non-relational data stores, graph databases, flat files, and other data storage technologies. ADD components 201 can further include streaming components 201b that facilitate rapid distribution of data to numerous system endpoints, such as message queues, stream processing software, and other data distribution systems. ADD components 201 can further include source code management components 201c, such as Git, Mercurial, Subversion, and other similar source management systems. Source code management components 201c can also include cloud-based servers for version control, such as GitHub or GitLab. ADD components 201 can further include application definition and image build components 201c that allow developers to define cloud-based infrastructure, including configurations of application servers, software defined networks, and containerized services. ADD components 201 can further include continuous integration and continuous delivery (Cl/CD) components 201d that automate the process of application testing and deployment. Cl/CD components 201d can be configured to automatically run automated tests on application software (e.g., when a change is committed to a version control platform), and if the tests are successful, to deploy the application software to a production environment.

Orchestration and management (“OM”) components 202 facilitate the containerization and subsequent coordinated execution of application software. OM components 202 include scheduling and orchestration components 202a that schedule and run containerized software. Non-limiting examples of scheduling and orchestration components 202a include Kubernetes and Docker Swarm. OM components 202 can further include coordination and service discovery components 202b that allow software to automatically discover cloud-based resources, such as data stores, data streaming sources, etc. OM components can further include service management components 202c that can include load balancers, reverse proxy systems, auto scalers, and other components that facilitate autonomous or manual application scaling.

Runtime components 203 can include basic environments to support execution of cloud-based application software. Runtime components 203 can include cloud-native storage 203a, such as object stores, virtual file systems, block storage, and other forms of cloud-centric data storage. Runtime components 203 can include container runtimes 203b that provide the foundation for containerized application software, such as Docker or Rkt. Runtime components 203 can further include cloud-native network components 203c that provide software-defined networking and virtual private cloud technologies that enable components of cloud-based systems to communicate with each other, as well as with the wider Internet.

Provisioning components 204 can include components intended for configuring cloud components and triggering the creation of cloud resources on various cloud platforms. Provisioning components can include Host Management and Tooling components 204a that define and deploy configurations of cloud components when executed. Provisioning components 204 can further include infrastructure automation components 204b that automate basic cloud infrastructure tasks. Provisioning components 204 can further include container registries 204c that provide storage for containerized cloud applications that are deployable by other provisioning components. Provisioning components can further include secure image components 204d that provide security and verification for container images to ensure consistent and reliable deployment of trusted container images. Provisioning components can further include key management systems 204e that provide for secure storage of cryptographic keys.

Serverless components 205 can include components for deploying cloud applications that do not rely upon a continuously-running (or scheduled) runtime execution, but instead run discrete components of functionality given a condition. Serverless components 205 can include components 205a to simplify the development of serverless applications, such as components that convert server-centric software into serverless code, event simulators, and simulations of cloud-based serverless platforms. Serverless components 205 can also include frameworks 205b that are predefined systems that take code in certain configurations and deploy them as serverless applications in cloud environments. Serverless components 205 can also include security components 205c that help to secure serverless applications.

Observability & Analysis components (“O&A”) 206 can include systems for monitoring running cloud applications, detecting and observing defects and errors, and logging system performance. O&A components 206 can include monitoring components 206a that monitor running systems to display and/or record performance metrics, error rates, and other application data. O&A components 206 can also include logging components 206b that collect system logs from cloud-based components and aggregate them in a single place or to a single access point to review system performance. O&A components 206 can also include tracing components 206c that collect detailed trace logs when cloud components run into errors, system exceptions, and other problematic behaviors to assist in the identification and remediation of problems in cloud-based systems.

In some embodiments, one or more methods are embodied in a set of instructions for one or more processors having access to one or more types of memory. The instructions could be coded in hardware or in software. Many kinds of platforms may be used, including, but not limited to: computers, mobile devices, tablets, game consoles, network management devices, field-programmable gate arrays, and cloud-based computer systems. Aspects of the disclosure could be deployed on multiple devices for concurrent operation. Embodiments may be used as a component of a larger system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module”, or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In some embodiments, the computer readable medium can be a non-transitory storage system on a cloud platform, such as, for example, in a database or data warehouse component 201a, a source code management tool 201c, cloud-native storage component 203a, embodied in a container image stored locally or in a container registry 204c, or deployed in a container runtime 203b. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including, but not limited to wireless, wireline, optical fiber cable, RF, etc., or any suitable combination of the foregoing.

Computer program code for carrying out operations for aspects of the present invention may be written in any combination of one or more programming languages, including languages such as Java, Python, Go, Ruby, Javascript, Smalltalk, C++ or the like. As defined herein, computer program code also includes the build artifact of any of the above languages, or similar languages and environments, such as object code, byte- or word-code, or other compiled, interpreted, or processed code. The program code may execute entirely on the user's computer, partly on the user's computer, as a stand-alone software package, partly on the user's computer and partly on a remote computer or entirely on one or more remote computers, servers, or serverless cloud platforms. In the latter scenario, the remote computer may be connected to the user's computer through any type of network, including a local area network (LAN) or a wide area network (WAN), or the connection may be made to an external computer (e.g., through the Internet using an Internet Service Provider).

Aspects of embodiments of the present invention that are described above with reference to flowchart illustrations and/or block diagrams of methods, apparatus (systems) and computer program products according to embodiments of the invention. The flowchart and/or block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The disclosed technology is disclosed in terms of modules and submodules, each of which are to be understood as discrete units of functionality, which can be embodied as classes, modules, functions, compilation or build artifacts, or other components of one or more programming languages used to implement embodiments of the disclosed technology. While the present description illustrates one organization of the various modules and submodules for implementing embodiments of the disclosed technology, the invention is not so limited. Embodiments of the presently disclosed technology can include other organizations for implementing equivalent or overlapping functionality for the various modules described herein, such as by sharing functionality between modules, combining modules, separating modules into multiple modules, implementing class hierarchies and the like. Additionally, the accompanying drawings illustrate example relationships between various modules and submodules (such as by flowchart connectors or inclusion of modules as sub-modules of other modules), but these relationships are not limiting. As would be recognized by a person of ordinary skill in the art, the output of any given module is available to be included as part of the input of any other component in accordance with various embodiments. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatuses, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments described herein were chosen and described in order to best explain the principles of the invention and the practical application, and to enable others of ordinary skill in the art to understand the invention for various embodiments with various modifications as are suited to the particular use contemplated.

Technical effects and benefits include reducing travel time for vehicles, improving revenue generation from toll roads, and improved roadway safety from actively managed roadways.

In some embodiments, the traffic data management system performs a calculation and makes a decision based on the input data for a time interval on a road segment, such as input data received in real time. Examples of such a calculation can include determining a preferred route from a plurality of routes, determining a speed limit for a road segment, or determining a toll rate for a road segment. In some embodiments, a pre-existing system can be in use that makes such decisions using a predetermined algorithm, such as a programmed function, machine learning model, artificial neural network, or other computational system. In such embodiments, the presently disclosed technology can be used to detect instances where the decision made by the predetermined algorithm is anomalous or otherwise unexpected. By implementing the disclosed technology in such circumstances, the health of the predetermined algorithm can be monitored, or the predetermined algorithm can be augmented to produce less anomalous or non-anomalous results. In other embodiments, the predetermined algorithm can be omitted, and instead, a calculation can be performed solely as a result of the techniques discussed herein.

An example embodiment of the disclosed technology is in a managed toll lane system (MTLS). Such a system can comprise one or more road segments, where at least one of the road segments includes both managed and unmanaged lanes. The MTLS can receive historical data, including the toll price charged, for the road segments as described above. The toll price in the historical data can be obtained from a predetermined algorithm, such as a preexisting tolling model implemented by the MTLS.

The MTLS can then vectorize the historical data, and train an isolation forest from that data. The historical data can be annotated with anomaly scores from the isolation forest, and then those rows in the historical data with an anomaly score above a threshold can be clustered into one or more anomaly clusters. Support staff can then review the rows falling within each one of the clusters to determine an adjustment rule that should apply to points within that cluster. The presence of the historical data means that such adjustments can be applied to the historical data, and anomaly scores recalculated to observe whether the adjustments reduced the anomaly scores within the cluster.

Alternatively, as described above, the MTLS can determine adjustment rules for each cluster automatically in accordance with the techniques previously described. While the MTLS is in service, it can monitor real-time input data corresponding to a time interval, and calculate an anomaly score corresponding to that interval. If the anomaly score exceeds a predetermined threshold, the MTLS can then categorize the real-time input data into one of the anomaly clusters. For example, a centroid can be calculated for the anomalous rows in each anomaly cluster in the historical data, and then the distance of the vectorized input data can be calculated to each centroid. The cluster having the nearest centroid is likely to be the cluster to which the real-time data corresponds. The MTLS can then apply the adjustment rule corresponding to that cluster. An MTLS is a single example of a traffic management system in accordance with an embodiment, however, other traffic management systems (“TMS”) are contemplated hereby.

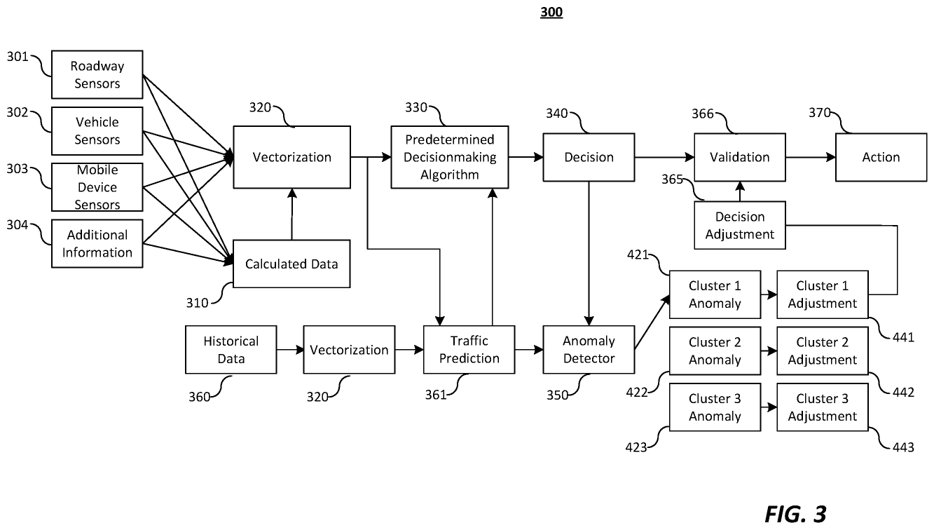

FIG. 3 depicts a TMS 300 in accordance with an embodiment. Such a system can receive data from a plurality of sources, including, but not limited to (1) sensors mounted on or in proximity to the roadway 301, (2) sensors mounted on vehicles 302, or (3) sensors contained within an individual's mobile devices 303 and other devices. Such sources are not intended to be limiting; aspects of the present invention can also include data obtained about the roadway and traffic conditions thereon regardless of source. The data received by the system can comprise various attributes about traffic conditions at the time the measurement is taken, such as speed, relative spacing between vehicles, current lane, how many vehicles have passed over a current spot, etc. In some embodiments, such as those implemented on managed toll lanes, other types of data can be collected, such as toll counts (e.g., how many vehicles have paid a toll, either by stopping at a physical booth, or passing through a sensing gate (e.g., RFID reader, license plate reader, etc.).

Additional information 304 can also be received that is not directly related to traffic, but has an impact on traffic. Such data can include date and time information, such as the current time of day or calendar date. Such data can also include special date information, such as whether a day is a weekday, weekend, or holiday, whether local schools are in session, whether the city offices are open or closed (e.g., due to a natural disaster), etc. Such data can also include special event information, such as whether there is a major event (sporting event, convention, etc.) occurring in the vicinity, construction projects, etc. Such data can also include weather information, such as whether it is raining, rainfall rates, current temperature, current cloud cover, wind speed, wind direction, and hazardous weather alerts (flash flood warnings/watches, hurricane/tornado warnings/watches, etc.).

From this raw data, additional data attributes can be calculated (“calculated traffic data 310”). This can include simple calculation of vehicle detection rates from detection counts, applying categorical thresholds (e.g., is the atmospheric temperature above or below freezing?), or other similar calculations. More advanced calculations can be applied, such as, for example, calculating a probability of ice on the road. Such a calculation may need to take into account, for example, rainfall rates, current temperature, relative humidity, and how long it has been raining.

Data obtained by the TMS can be provided as real-time information, and/or as a historical data set 360 comprising any of the data discussed above over a period of time. Preferably, the same data attributes available in the real-time data are available in the historical data set.

Calculated traffic data 310 for a time interval can also include predicted future information about the road segment, or other road segments. Predicted future information can be based on historical data for similar times and dates, based on extrapolating current information based on recent trends, or produced as the result of a predictive machine learning system (e.g., an artificial neural network, SVM, or other decision model). A collection of data attributes for each time interval, for each road segment can comprise an input data row, and a collection of input data rows for a plurality of time intervals and/or road segments can comprise an input data set. This input data set can then be vectorized into a vectorized data set.

Conversion of the input data attributes into a vector can be referred to as vectorization 320. To facilitate analysis of the input data set, the data attributes for each input row can be converted into a vector in n-dimensional space, wherein each dimension is one of the data attributes for the interval, and the magnitude of the interval in each dimension is calculated as a function of the data attribute. Vectorization of the data can comprise applying one or more rules to one or more attributes of the data set. In some embodiments, vectorization rules can comprise encoding rules, feature selection rules, standardization rules, and dimensionality reduction rules. However, as would be recognized by a person of ordinary skill in the art, each of these categories of steps may be omitted in certain circumstances. For example, if all data attributes are already numeric, no encoding is necessary.

Encoding steps convert one or more attribute values into a format suitable for analysis. For example, attribute values can be organized into time intervals. Such intervals can be short, such as a second, a minute, or five minutes, or can be longer, such as a half-hour, hour, 6 hours, 12 hours, 1 day, or more. Each interval can comprise a plurality of data attributes selected or calculated from the raw traffic data and calculated traffic data, and corresponding to that interval. Such attributes can be a single representative value from the time interval (e.g., mean/median/average roadway speed for a particular segment), or a plurality of representative values (e.g., 25-50-75 percentiles for roadway speed in the interval). Attributes for a time interval can also include information from past intervals, such as, for example, average roadway speed for a segment for the last 1, 2, 5, or 10 intervals. Attributes for a time interval can also include information from other road segments that are adjacent to, feed into, or out of, or otherwise affect roadway conditions on the road segment.

As another example of encoding, if the attribute has an ordinary numeric value, the number can be used as-is (or cast to an appropriate data type, e.g., integers, doubles, etc.). Alternatively, such numeric values can be binned or binarized. For example, if the distribution of a data attribute runs from 0 to 500, the distribution could be binned into groups of 100 (e.g., bin 0: 0-100, bin 1: 101-200, bin 2: 201-300, bin 3: 301-400, bin 4: 401-500), and encoded into bin position (e.g., 55 minutes=>0, 198 minutes=>1). Binarization is a special case of binning with two bins, where a threshold value is determined, and values are encoded as either 0 for below the threshold, or 1 for above the threshold.

If the attribute is ordered categorical data, the categorical data can be encoded as an integer value indicating its position. The attributes can also be vectorized into standard deviations from a mean value. If the attribute is a compound data object, such an array, structure, map, or similar indexed/keyed data structure, the vectorization rule can be a function to perform on the data to extract a numeric value, such as picking a particular value from the structure, or calculating a statistic based on the structure. In some embodiments, the vectorization rules can produce multiple output columns for one or more input columns. For example, a single numeric value can be vectorized into a first column by using the numeric value directly and into a second column as a bin number. Alternatively, a vectorized column can be vectorized as a ratio or comparison between multiple input columns

Vectorization 320 can also comprise standardization rules to standardize, scale, center, or perform other statistical numeric transformations. Such transformations can include scaling the values to a range (e.g., normalization between 0 and 1), centering on average value, scaling to a known distribution (e.g., Gaussian distribution), filling in missing data (e.g., either a zero or a computed value such as an average value), or eliminating outliers (e.g., data beyond a certain distance, such as number of standard deviations, from the mean).

Vectorization 320 can also comprise dimensionality reduction techniques. As is known in the art, machine learning and statistical estimation often suffers from the “curse of dimensionality,” having too many dimensions or degrees of freedom to feasibly calculate. Therefore, vectorization can, in some embodiments, comprise dimensionality reduction techniques, such as principal component analysis (PCA), non-negative matrix factorization (NNMF), and latent Dirichlet allocation (LDA), and other techniques known in the art.

Vectorization 320 can also comprise feature selection criteria. In some embodiments, not all attribute values are used. In general, it is desirable for the selected data attributes to not be highly correlated with each other. From the available attribute values, certain attributes can be included or excluded based on industry expertise or hypotheses about correlations in the data. Using multiple highly correlated input values can increase the computational complexity of training the model without meaningfully improving performance. One method of eliminating correlated data is to calculate a correlation coefficient between each pairwise set of attribute values, aggregating attributes into groups or categories of correlated attribute values, and then dropping all but one or a few of the correlated attribute values in each of the groups of correlated attribute values. This correlation coefficient-based technique can be applied at any stage of the vectorization process, either to the raw attribute values, encoded attribute values, or standardized attribute values.

In some embodiments, a traffic prediction 361 step can be applied to vectorized data. In this step, the values of the vectorized traffic data is predicted at a predetermined time interval in the future. Any predicting modeling technique as is known by a person of ordinary skill in the art can be used for traffic prediction 361, including but not limited to regression techniques. In some embodiments, traffic prediction 361 can be performed using an artificial neural network. In some embodiments, such artificial neural network can utilize architectures intended to predict time series information, such as a recurrent neural network, or long-term/short-term memory (LTSM) network.

In some embodiments, a TMS 300 can include a predetermined decisionmaking algorithm 330. This algorithm can comprise a pre-existing module, system, or other pre-existing component for receiving input data 301-304 and producing a decision 340. The predetermined decisionmaking algorithm 330 can comprise a plurality of rules, if-then statements, or other procedural software in some embodiments. In some embodiments, the predetermined decisionmaking algorithm 330 can receive as input vectorized data 320 or predicted traffic data from traffic prediction technique 361. In some embodiments, the predetermined decisionmaking algorithm 330 can comprise a machine learning model, such as an artificial neural network, decision tree, support vector machine, or other similar model. The predetermined decisionmaking algorithm 330 can produce a decision 340, such as a decision to set or adjust a toll price (in the case of a MTLS), or to set or adjust other traffic-related features, such as speed limits, traffic flow control devices, automatic gates, lighting or signage, and other similar features.

In some embodiments, the traffic management detection system can comprise an anomaly detection technique 350, performed on either the input data alone (either vectorized 320 or not), or the input data combined with a decision 340 made by the TMS 300. In some embodiments, the anomaly detection technique 350 can be performed using predicted traffic data generated by traffic prediction technique 361. This anomaly detection 350 can be performed against a historical data set 360 that comprises prior input data 301-304 (either vectorized 320 or not) and prior decisions 340 (if a predetermined decisionmaking algorithm 330 is present) to determine, for example, whether the current input data 301-304 is anomalous, or whether the decision 340 in view of the input data 301-304 is anomalous. The historical data 360 can comprise, for example, data from the prior month, prior year, or any other time interval. Such historical data can also be a trailing window of data—such as the prior six months, prior year, etc.

Examples of anomaly detection techniques that can be performed include a robust covariance, one-class support vector models, isolation forests, and Local Outlier Factor (“LOF”), among other anomaly detection techniques as are known in the art. One class of techniques that are useful for embodiments are isolation forests. This technique takes advantage of two quantitative properties of anomalies: i) they are the minority consisting of few instances, and ii) they have attribute-values that are very different from those of normal instances. In other words, anomalies are ‘few and different’, which make them more susceptible to isolation. Isolation can be implemented by any means that separates instances. One method is to use a binary tree structure called an isolation tree (iTree), which can be constructed effectively to isolate rows. Because of the susceptibility to isolation, anomalies are more likely to be isolated closer to the root of an iTree; whereas normal points are more likely to be isolated at the deeper end of an iTree.

Isolation Forest (iForest) techniques build an ensemble of iTrees for a given data set; anomalies are those instances which have short average path lengths on the iTrees. There are two training parameters and one evaluation parameter in this method: the training parameters are the number of trees to build and subsampling size; the evaluation parameter is the tree height limit during evaluation. We show that iForest's detection accuracy converges quickly with a very small number of trees; it only requires a small subsampling size to achieve high detection accuracy with high efficiency; and the different height limits are used to cater for anomaly clusters of different density.

Isolation means “separating an instance from the rest of the instances.” In general, an isolation-based method measures individual instances' susceptibility to be isolated; and anomalies are those that have the highest susceptibility. To realize the idea of isolation, data structures can be used that naturally isolate data. In randomly generated binary trees where instances are recursively partitioned, these trees produce noticeable shorter paths for anomalies since (a) in the regions occupied by anomalies, less anomalies result in a smaller number of partitions—shorter paths in a tree structure, and (b) instances with distinguishable attribute-values are more likely to be separated early in the partitioning process. Hence, when a forest of random trees collectively produce shorter path lengths for some particular points, they are highly likely to be anomalies.

Anomaly detection using iForest is a two-stage process. The first (training) stage builds isolation trees using sub-samples of the given training set. The second (evaluation) stage passes test instances through isolation trees to obtain an anomaly score for each instance. In the training stage, iTrees are constructed by recursively partitioning a sub-sample X′ until all instances are isolated. Details of the training stage can be found in Algorithms 1 and 2. Each iTree is constructed using a sub-sample X′ randomly selected without replacement from X, X′⊂X.

In some embodiments, there are two input parameters to the iForest algorithm: the subsampling size ψ and the number of trees t. Subsampling size ψ controls the training data size. We find that when ψ increases to a desired value, iForest detects reliably and there is no need to increase ψ further because it increases processing time and memory size without any gain in detection accuracy. As we assume that anomalies are few and different, normal points are also assumed to be many and similar. Under these assumptions, a small subsampling size is enough for iForest to distinguish anomalies from normal points. Number of trees t controls the ensemble size. We find that path lengths usually converge well before t=100. At the end of the training process, a collection of trees is returned and is ready for evaluation. The worse case time complexity of training an iForest is O(tψ2) and the space complexity is O(tψ).

In the evaluation stage, a single path length h(x) is derived by counting the number of edges e from the root node to an external node as instance x traverses through an iTree. When the traversal reaches a predefined height limit hlim, the return value is e plus an adjustment c(Size). This adjustment accounts for estimating an average path length of a random sub-tree which could be constructed using data of Size beyond the tree height limit. When h(x) is obtained for each tree of the ensemble, an anomaly score is computed. The anomaly score and the adjustment c(Size) are to be defined in the next subsection. The worse case time complexity of the evaluation process is O(ntψ), where n is the testing data size.

An anomaly score can be calculated for each row in a data set. Since iTrees have an equivalent structure to Binary Search Tree (“BST”), the estimation of average h(x) for external node terminations is the same as that of the unsuccessful searches in BST. We borrow the analysis from BST to estimate the average path length of iTree. Given a sample set of w instances, the average path length of unsuccessful searches in BST is:

$$c ( ψ ) = \{ \begin{matrix}2 H ( ψ - 1 ) - 2 ( ψ - 1 ) / n & for ψ > 2 \\ 1 & for ψ = 2 \\ 0 & otherwise\end{matrix}$$

where H(i) is the harmonic number and can be estimated by ln(i)+0.5772156649 (Euler's Constant). As c(ψ) is the average of h(x) given ψ, it can be used to normalize h(x). The anomaly score s of a row can then be defined as, for example:

$$s ( x , ψ ) = {2}^{- \frac{E ( h ( x ) )}{c ( ψ )}}$$

A point is more likely to be an anomaly as the score approaches 1, and less likely to be anomalous as the score approaches 0. A point can then be determined to be anomalous if the anomaly score is over a particular threshold, such as, for example, 0.5.

Isolation forests techniques are well-suited for embodiments of the disclosed technology, because they work well for highly-dimensional data, and are computationally efficient. Many implementations have linear or near-linear complexity bounds (i.e. O(n)). Further, isolation forests can facilitate visualization of outlier boundaries, as contours of a constant anomaly score can be calculated. By applying an isolation forest to the input data, an anomaly score can be calculated for each input value. Further, by training an isolation forest, the same forest can be applied to future data to calculate an anomaly score given the historical data set. In some embodiments, an isolation forest technique can be performed on a vectorized historical data set, and the anomaly score calculated for each, or a plurality of, rows in the vectorized historical data set. These anomaly scores can be added as an additional dimension of the vectorized historical data set.

In embodiments where anomaly detection 350 is not performed on decisions made by a predetermined algorithm 330, anomaly detection 350 can be used to monitor the health of the input data sources 301-304. That is, rows having a high anomaly score can indicate that sources of input data 301-304 are not operating correctly, or that the roadway is experiencing a rare and unexpected set of circumstances. In embodiments where the anomaly detection 350 is performed on decisions 340 made by a predetermined algorithm 330, anomaly detection 359 can be used to monitor the health of the predetermined algorithm. That is, combinations of input data 301-304 and a decision 340 having a high anomaly score may indicate suboptimal performance of the predetermined algorithm 330, and identify instances where the predetermined algorithm 330 should be modified or augmented. In some embodiments, the anomaly scores of historical data can be analyzed to identify times in the past where erroneous or unexpected behavior has occurred, or the anomaly score of real time data can be calculated to determine whether an anomalous condition is currently occurring. Such embodiments follow the same data path as the TMS 300 described herein, but the input data 301-304 is simulated from a point in time from the historical data 360.

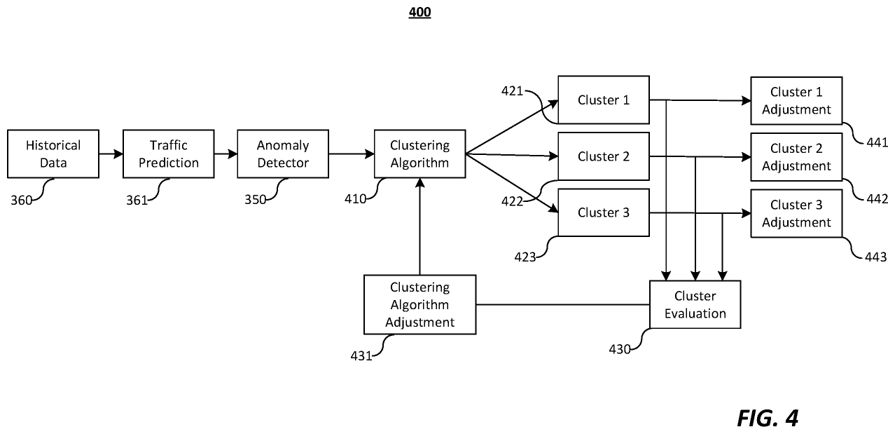

FIG. 4 depicts a process identifying anomaly types 400, in accordance with an embodiment. In some embodiments, a historical data set 360 that has been annotated with anomaly scores by the anomaly detector 350 can be used to identify particular types of anomalies using a clustering algorithm 410. In some embodiments, the anomaly scores are calculated by the anomaly detector 350 based on predicted traffic data produced by a traffic prediction technique 361. In some embodiments, identification of anomaly types can be used to assist support staff in identifying the failure mode and correcting the anomalous conditions. In some embodiments, the identified anomaly types can be automatically corrected by a TMS in accordance with embodiments. This clustering 410 can either be performed on all historical input data, to determine clusters of similar points generally, or can be applied only to that historical data that is considered “anomalous” as determined by an anomaly detection technique.

To identify anomaly types, a clustering algorithm 410 can be performed on the vectorized data set. This clustering can be performed by an automatic segmentation mechanism, wherein each row in the vectorized data set is divided into groups, where each row in the group is relatively similar to others in the group, and is relatively dissimilar from members of other groups. A variety of techniques exist for clustering data in this manner. Automatic clustering algorithms that are known in the art include k-Means, Affinity Propagation, Mean Shift, Spectral Clustering, Ward Clustering, Agglomerative Clustering, DBSCAN, Birch, and Gaussian Mixture. Each of these techniques first require as input a plurality of points in n-dimensional space, such as vectorized data 320.

In some embodiments, the clustering algorithm 410 can be provide a predetermined number of groups into which to subdivide the input data. In some embodiments, the number of groups can be programmatically selected by repeating the clustering algorithm with various numbers of groups, and evaluating the quality of the clusters, and selecting a number of groups that provides the best performance. In such a process, the quality of the individual clusters can be evaluated 430, and adjustments 431 to the clustering algorithm can be made based on that evaluation. Many clustering algorithms, likewise, can use various distance measures to evaluate the quality of individual clusters. While the default in most circumstances is Euclidean distance (e.g., straight line distance), many other distance metrics can be used, such as squared Euclidean distance, standardized Euclidean distance, cosine distance, Manhattan distance, Bray-Curtis distance, Canberra distance, Chebyshev distance, Jensen-Shannon distance, Mahalanobis distance, Minkowski distance, and other distance metrics as are known in the art.

The clusters can also be evaluated 430 to ensure adequate performance. Evaluation criteria can include, for example, determining the average density of each cluster, distortion (mean sum of squared distances to centers), intercluster distances, calculating the Variance Ratio Criterion (Calinski Harabaz score), calculation of a silhouette score (mean ratio of intra-cluster and nearest-cluster distance), or other similar metrics. These performance criteria can be compared to a minimum or maximum acceptable value. Alternatively, the clustering can be repeated using different vectorization rules, algorithms, desired number of groups, and/or distance measures, and the scores recalculated to see if they improve or worsen. Techniques for such evaluation can also comprise generating an elbow chart (e.g., mapping one or more fit scores/computational performance metrics against choices for number of groups), silhouette visualizations, or intercluster distance maps. Where a vectorized data set has been clustered, the vectorized data set can be annotated with an additional dimension corresponding to its cluster membership. (e.g., Cluster 1, Cluster 2, etc.)

Because each cluster 421-423 represents anomalous rows that are similar to one another, each cluster can be considered an anomaly type. Once time interval data is divided into clusters, a set of rules or algorithmic technique can be applied to the data points in the cluster to make an adjustment 441-443. For example, a human programmer can review the points categorized into a single cluster, and study why those points are anomalous. The human programmer can then apply knowledge obtained from the data set, domain knowledge (e.g., knowledge about traffic patterns and roadway conditions) and other expertise to derive a calculation or rule that applies to the cluster.

In some embodiments, where an existing technique is used to calculate decisions, the TMS can determine adjustments 441-443 to calculate decisions automatically. In some embodiments, such an adjustment can be calculated on a cluster-by-cluster basis. One method of doing this would be to calculate the average adjustment to the decision that, if added to each vector in a cluster of anomalous vectors, would reduce the anomalousness of the vector, such as by lowering its anomaly score below a predetermined threshold. Another method of doing this would be to calculate the centroid of each cluster of anomalous vectors, and determine an adjustment necessary to move the centroid of the anomalous vectors such that it would have an anomaly score below a predetermined threshold.

In some embodiments, where the anomaly detection 350 is performed on a data set containing decisions, the TMS can automatically determine an adjustment 441-443 to the decision based on historical data in the absence of clustering. In some embodiments, an anomalous vector can be analyzed to determine a gradient of anomaly score along the dimension of the decision. Stated another way, the TMS can determine how the decision should be adjusted to reduce the anomaly score of the point (e.g., by a predetermined amount, or such that the anomaly score falls below a given threshold).

A simple gradient calculation can be performed by gradient descent techniques as are well known in the art. For example, an anomaly score can be calculated for a point as a small distance in a random direction from the specific data point. If the anomaly score decreases in that direction, the decision can be moved in that direction. If the anomaly score increases in that direction, the decision can be moved in the opposite direction. The process then repeats until a terminating condition is met, such as by having an anomaly score reduced by a predetermined amount, reducing it below a predetermined threshold, or finding a local minimum.

In other embodiments, the TMS can determine how the decision should be adjusted by performing a k-nearest neighbors (“KNN”) search around the anomalous point for non-anomalous points. The decision can then be adjusted to match the predicted value for the nearest non-anomalous point, or an average of a predetermined number of nearest non-anomalous points, or the direction of the nearest non-anomalous point can be used as a direction, and then the decision corresponding to the row can be adjusted in that direction until its anomaly score falls below a predetermined threshold.

The adjustments 441-443 can be used in the TMS 300 where the anomaly detector 350 determines an anomalous condition. The anomaly detector can assign the vector representing an anomalous condition to one of the predetermined clusters 421-423 from system 400, and then apply the corresponding adjustment 441-443. In some embodiments, the anomaly detector can assign the anomalous vector to the predetermined clusters 421-423.

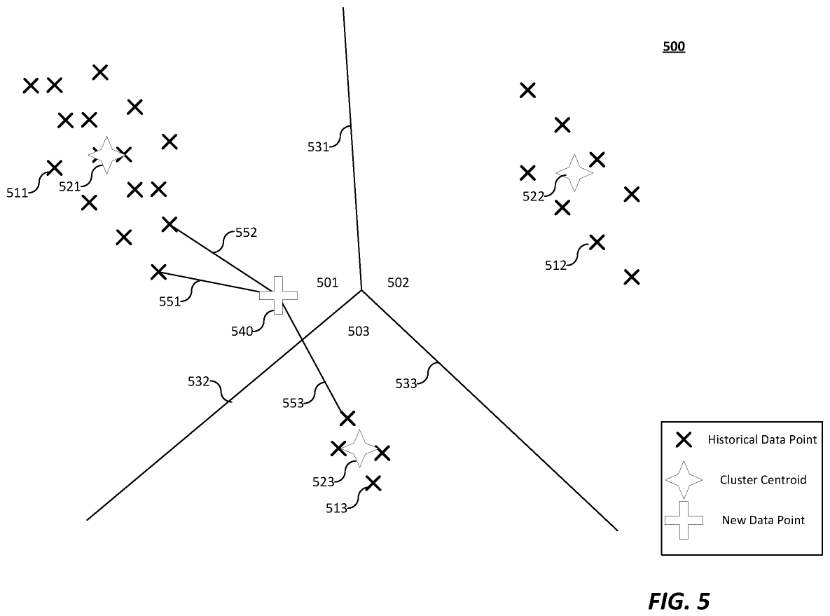

FIG. 5 depicts an example process 500 for assigning new points to existing clusters. The process in FIG. 5 is a simplified form of clustering, reduced to two dimensions, for ease of explanation. As will be understood by persons of ordinary skill in the art, similar techniques can be applied to higher-dimensional spaces, including spaces not visualizable (e.g., 100 or more dimensional space). The clustering algorithm 410 divides a plurality of historical data points (e.g., 511-513) into a plurality of clusters 501-503. The centroid of each cluster 521-523 can be calculated as the average or mean point for the points assigned to that cluster. Boundary lines 531-533 can be calculated between each of the clusters 501-503 by dividing the plotting space into Voroni cells by partitioning the available space into regions closest to each centroid, resulting in boundaries 531-533. A new data point 540, such as a vector representing input data 301-304 and/or a decision 340, can be assigned to a cluster by comparing the new data point 540 to the cluster boundaries 531-533, and assigning it to the cluster corresponding to the region within which new data point 540 falls. For example, new data point 540 would be assigned to cluster 501. Another example technique for assigning a new data point 540 to a cluster would be to perform a KNN search for a predetermined number of historical data points, and assigning the point to the cluster corresponding to the majority of nearest neighbors. For example, if a KNN search for the three nearest neighbors was conducted for new data point 540, two of the nearest neighbors would belong to cluster 501 (as shown by lines 551 and 552), and one neighbor would belong to cluster 503 (as shown by line 553). Accordingly, new data point 540 would be assigned to cluster 501.

Once a new data point 540 has been assigned to a corresponding cluster 501-503, the corresponding adjustment can be performed. Returning to FIG. 3, if an anomaly is detected by anomaly detector 350, the anomaly detector can assign the anomaly to one of clusters 421-423. In the example depicted in FIG. 3, the anomaly is determined to be a Cluster 1 Anomaly 421. A corresponding adjustment rule 441 is then applied to the anomalous data, and provided to an adjustment module 365, which provides the adjustment to the decision 340, as determined by the predetermined decision making algorithm 330. In some embodiments, the decision adjustment 365 can be validated 366 prior to application. For example, the validation process 366 can perform quality control on the decision adjustment 365 to ensure that the output to the action 370 is reasonable. Examples of such validation include ensuring compliance with business rules (e.g. minimum or maximum speed limits, tolls), and reasonableness (e.g. within a maximum variation of previous values). If validation 366 fails, the decision 340 from the predetermined decisionmaking algorithm 350 can be based through to action 370 without applying decision adjustment 365. An action 370 is then performed in accordance with the adjusted decision by, for example, setting a toll, adjusting a speed limit, opening or closing traffic flow control devices, activating signage or displaying messages thereon, or other similar traffic-related actions.

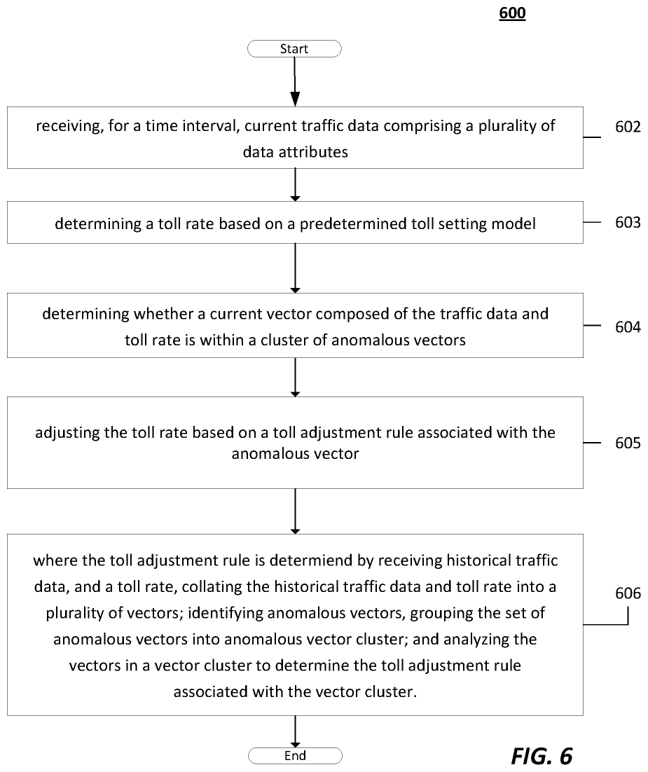

FIG. 6 depicts a computer-implemented method for determining a toll rate for a toll road 600, in accordance with an embodiment. In some embodiments, the method comprises the step 602 of receiving, for a time interval, current traffic data comprising a plurality of data attributes, composed of: roadway traffic data, tolling traffic data, and calculated traffic data. In some embodiments, the method comprises the step 603 of determining a toll rate based on a predetermined toll setting model. In some embodiments, the method comprises the step 604 of determining whether a current vector composed of the traffic data and toll rate is within a cluster of anomalous vectors. In some embodiments, the method comprises the step 605 adjusting the toll rate based on a toll adjustment rule associated with the anomalous vector. In some embodiments, the toll adjustment rule is determined 606 by receiving, for a plurality of time intervals, historical traffic data comprising the plurality of data attributes, and a toll rate corresponding to each time interval, collating the historical traffic data and toll rate into a plurality of vectors, wherein each vector comprises the traffic data and toll rate corresponding to a single time interval;

identifying a plurality of anomalous vectors from within the plurality of vectors, where each vector in the set of anomalous vectors is anomalous relative to the plurality of vectors; grouping the set of anomalous vectors into a plurality of anomalous vector clusters, wherein each anomalous vector cluster comprises a subset of anomalous vectors selected from the set of anomalous vectors, and wherein each anomalous vector in an anomalous vector cluster is closer to other anomalous vectors in the anomalous vector cluster than to anomalous vectors in other anomalous vector clusters, according to a distance metric; and analyzing the vectors in a vector cluster to determine the toll adjustment rule associated with the vector cluster.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A computer-implemented method for managing traffic on a roadway, comprising:
receiving, for a time interval, traffic data comprising a plurality of data attributes, composed of:
roadway traffic data received from sensors mounted on or in proximity to the roadway, and
calculated traffic data;
determining a traffic management decision using a predetermined traffic management model,
determining whether a vector composed of the traffic data and traffic management decision is within a cluster of anomalous vectors and is therefore an anomalous vector, and
adjusting the traffic management decision based on a traffic management adjustment rule associated with the anomalous vector, wherein the traffic management adjustment rule is determined by:
receiving, for a plurality of historical time intervals, historical traffic data comprising the plurality of data attributes, and a historical traffic management decision corresponding to each time interval,
collating the historical traffic data and the historical traffic management decision into a plurality of historical vectors, wherein each vector in the plurality of historical vectors comprises the historical traffic data and historical traffic management decision corresponding to a single time interval;
identifying a plurality of anomalous vectors from within the plurality of historical vectors, where each vector in the plurality of anomalous vectors is anomalous relative to the plurality of historical vectors;
clustering the set of anomalous vectors into a plurality of anomalous vector clusters according to a distance metric; and
analyzing the vectors in a vector cluster to determine the traffic management adjustment rule associated with the vector cluster.

2. The method of claim 1, wherein the step of analyzing the vectors in a vector cluster to determine the traffic management adjustment rule associated with the vector cluster comprises determining a traffic management adjustment rule that, when applied to the vectors in the vector cluster, would reduce the anomalousness of the vectors in the vector cluster.

3. The method of claim 1, wherein the step of determining whether a vector composed of the traffic data and traffic management decision is within a cluster of anomalous vectors comprises, for each vector cluster in the plurality of vector clusters:
determining a centroid of the vector cluster,
determining a standard deviation of the distance of each vector in the vector cluster from the centroid, and
determining that the vector is within a cluster of anomalous vectors where the vector is closer than a predetermined number of standard deviations from the centroid of the vector cluster.

4. The method of claim 1, wherein the step of analyzing the vectors in a vector cluster to determine the traffic management adjustment rule comprises determining an average traffic management adjustment necessary to move each vector in the vector cluster to the closest vector in the plurality of vectors that is not in the plurality of anomalous vectors.

5. The method of claim 1, wherein the step of analyzing the vectors in a vector cluster to determine the traffic management adjustment rule comprises determining a traffic management adjustment necessary to move a vector representing a centroid of the vector cluster to the closest vector in the plurality of vectors that is not in the plurality of anomalous vectors.

6. The method of claim 1, wherein the step of identifying a plurality of anomalous vectors from within the plurality of vectors comprises:
determining an anomaly score for each vector in the plurality of vectors, and
identifying a vector in the plurality of historical vectors as an anomalous vector where the anomaly score for the vector is beyond a threshold anomaly score.

7. The method of claim 1, wherein the current traffic data and the historical traffic data comprise data attributes for a plurality of road segments.

8. A computing system for managing traffic on a roadway, the computing system comprising:
one or more memories having computer readable computer instructions; and
one or more processors for executing the computer readable computer instructions to perform a method comprising:
receiving, for a time interval, traffic data comprising a plurality of data attributes, composed of:
roadway traffic data received from sensors mounted on or in proximity to the roadway,
and
calculated traffic data;
determining a traffic management decision using a predetermined traffic management model,
determining whether a vector composed of the traffic data and traffic management decision is within a cluster of anomalous vectors and is therefore an anomalous vector, and
adjusting the traffic management decision based on a traffic management adjustment rule associated with the anomalous vector, wherein the traffic management adjustment rule is determined by:
receiving, for a plurality of historical time intervals, historical traffic data comprising the plurality of data attributes, and a historical traffic management decision corresponding to each time interval,
collating the historical traffic data and the historical traffic management decision into a plurality of historical vectors, wherein each vector in the plurality of historical vectors comprises the historical traffic data and historical traffic management decision corresponding to a single time interval;
identifying a plurality of anomalous vectors from within the plurality of historical vectors, where each vector in the plurality of anomalous vectors is anomalous relative to the plurality of historical vectors;
clustering the set of anomalous vectors into a plurality of anomalous vector clusters according to a distance metric; and
analyzing the vectors in a vector cluster to determine the traffic management adjustment rule associated with the vector cluster.

9. The computing system of claim 8, wherein the step of analyzing the vectors in a vector cluster to determine the traffic management adjustment rule associated with the vector cluster comprises determining a traffic management adjustment rule that, when applied to the vectors in the vector cluster, would reduce the anomalousness of the vectors in the vector cluster.

10. The computing system of claim 8, wherein the step of determining whether a vector composed of the traffic data and traffic management decision is within a cluster of anomalous vectors comprises, for each vector cluster in the plurality of vector clusters:
determining a centroid of the vector cluster,
determining a standard deviation of the distance of each vector in the vector cluster from the centroid, and
determining that the vector is within a cluster of anomalous vectors where the vector is closer than a predetermined number of standard deviations from the centroid of the vector cluster.

11. The computing system of claim 8, wherein the step of analyzing the vectors in a vector cluster to determine the traffic management adjustment rule comprises determining an average traffic management adjustment necessary to move each vector in the vector cluster to the closest vector in the plurality of vectors that is not in the plurality of anomalous vectors.

12. The computing system of claim 8, wherein the step of analyzing the vectors in a vector cluster to determine the traffic management adjustment rule comprises determining a traffic management adjustment necessary to move a vector representing a centroid of the vector cluster to the closest vector in the plurality of vectors that is not in the plurality of anomalous vectors.

13. The computing system of claim 8, wherein the step of identifying a plurality of anomalous vectors from within the plurality of vectors comprises:
determining an anomaly score for each vector in the plurality of vectors, and
identifying a vector in the plurality of historical vectors as an anomalous vector where the anomaly score for the vector is beyond a threshold anomaly score.

14. The computing system of claim 8, wherein the current traffic data and the historical traffic data comprise data attributes for a plurality of road segments.

15. One or more non-transitory computer-readable storage media containing machine-readable computer instructions that, when executed by a computing system, performs a method for managing traffic on a roadway, the method comprising:
receiving, for a time interval, traffic data comprising a plurality of data attributes, composed of:
roadway traffic data received from sensors mounted on or in proximity to the roadway,
and
calculated traffic data;
determining a traffic management decision using a predetermined traffic management model,
determining whether a vector composed of the traffic data and traffic management decision is within a cluster of anomalous vectors and is therefore an anomalous vector, and
adjusting the traffic management decision based on a traffic management adjustment rule associated with the anomalous vector, wherein the traffic management adjustment rule is determined by:
receiving, for a plurality of historical time intervals, historical traffic data comprising the plurality of data attributes, and a historical traffic management decision corresponding to each time interval,
collating the historical traffic data and the historical traffic management decision into a plurality of historical vectors, wherein each vector in the plurality of historical vectors comprises the historical traffic data and historical traffic management decision corresponding to a single time interval;
identifying a plurality of anomalous vectors from within the plurality of historical vectors, where each vector in the plurality of anomalous vectors is anomalous relative to the plurality of historical vectors;
clustering the set of anomalous vectors into a plurality of anomalous vector clusters according to a distance metric; and
analyzing the vectors in a vector cluster to determine the traffic management adjustment rule associated with the vector cluster.

16. The one or more non-transitory computer-readable storage media of claim 15, wherein the step of analyzing the vectors in a vector cluster to determine the traffic management adjustment rule associated with the vector cluster comprises determining a traffic management adjustment rule that, when applied to the vectors in the vector cluster, would reduce the anomalousness of the vectors in the vector cluster.

17. The one or more non-transitory computer-readable storage media of claim 15, wherein the step of determining whether a vector composed of the traffic data and traffic management decision is within a cluster of anomalous vectors comprises, for each vector cluster in the plurality of vector clusters:
determining a centroid of the vector cluster,
determining a standard deviation of the distance of each vector in the vector cluster from the centroid, and
determining that the vector is within a cluster of anomalous vectors where the vector is closer than a predetermined number of standard deviations from the centroid of the vector cluster.

18. The one or more non-transitory computer-readable storage media of claim 15, wherein the step of analyzing the vectors in a vector cluster to determine the traffic management adjustment rule comprises determining an average traffic management adjustment necessary to move each vector in the vector cluster to the closest vector in the plurality of vectors that is not in the plurality of anomalous vectors.

19. The one or more non-transitory computer-readable storage media of claim 15, wherein the step of analyzing the vectors in a vector cluster to determine the traffic management adjustment rule comprises determining a traffic management adjustment necessary to move a vector representing a centroid of the vector cluster to the closest vector in the plurality of vectors that is not in the plurality of anomalous vectors.

20. The one or more non-transitory computer-readable storage media of claim 15, wherein the step of identifying a plurality of anomalous vectors from within the plurality of vectors comprises:
determining an anomaly score for each vector in the plurality of vectors, and
identifying a vector in the plurality of historical vectors as an anomalous vector where the anomaly score for the vector is beyond a threshold anomaly score.

21. The one or more non-transitory computer-readable storage media of claim 15, wherein the current traffic data and the historical traffic data comprise data attributes for a plurality of road segments.

22. The computer-implemented method for managing traffic on a roadway of claim 1, wherein the traffic management decision is selected from the group consisting of: setting or adjusting a toll; setting or adjusting a speed limit, activating or deactivating a traffic flow control device, opening or closing an automatic gate, activating or deactivating lighting, and setting or adjusting signage.
